(19) United States
(12) Patent Application Publication
(10) Pub. No.: US 2025/0041887 A1
(43) Pub. Date: Feb. 6, 2025

(54) High pressure cleaning device

(71) Applicant: Andreas Stihl AG & Co. KG, Waiblingen (DE)

(72) Inventors: Christian Krauer, Weinstadt (DE); Alexander Kiebler, Kirchberg an der Murr (DE); Michael Renz, Stuttgart (DE)

(73) Assignee: Andreas Stihl AG & Co. KG, Waiblingen (DE)

(21) Appl. No.: 18/790,247

(22) Filed: Jul. 31, 2024

(30) Foreign Application Priority Data
Aug. 2, 2023 (DE) 102023120532.3

(51) Int. Cl. B05B 9/04; B08B 3/02

(52) U.S. Cl. CPC B05B 9/0413; B08B 3/026; B08B 2203/0211; B08B 2203/0223

(57) ABSTRACT

A pressure washer includes a motor for a high-pressure pump, a battery pack to supply the motor with energy, a battery compartment for the battery pack and a housing. The battery compartment has an insertion opening through which the battery pack can be inserted into the battery compartment. The battery compartment has a base body. The pressure washer has a protective element for protecting the battery compartment from liquid, which is arranged radially outside the base body of the battery compartment and has a protective surface. The battery compartment has a projection which projects radially beyond the base body of the battery compartment. The protective surface points in an insertion direction. The pressure washer has at least one angular sector around the insertion axis in which the protective element axially overlaps the projection such that the projection lies in front of the protective surface with respect to the insertion direction.

### CROSS-REFERENCE TO RELATED APPLICATION

This application claims the benefit of German Patent Application DE 102023120532.3, filed on Aug. 2, 2023, the content of which is incorporated by reference in its entirety.

### BACKGROUND

The application relates to a high pressure cleaning device, also referred to as a pressure washer.

In recent times, the use of batteries for operating high-pressure pumps has become significantly more attractive due to technical improvements, particularly with regard to battery capacity. However, one problem still remains that the battery pack must be protected from liquid and, if possible, be replaceable on the pressure washer.

### SUMMARY

The present application describes an improved pressure washer with a battery pack that can be accommodated in a battery compartment of the pressure washer in such a way that it is protected from liquid and can be quickly replaced.

According to the invention, the battery compartment has a longitudinal insertion end at which an insertion opening is arranged. The battery pack can be inserted into the battery compartment in an insertion direction along an insertion axis through the insertion opening. A circumferential direction extends around the insertion axis. The pressure washer has a protective element to protect the battery compartment from liquid. A radial direction runs radially to the insertion axis. In particular, the radial direction can point away from the insertion axis in any direction perpendicular to the insertion axis. The protective element has a protective surface. The protective surface is arranged outside a base body of the battery compartment with respect to the radial direction, in particular with respect to any radial direction, relative to the insertion axis.

The battery compartment has a projection in the region of the longitudinal insertion end. The projection protrudes in the radial direction beyond the base body of the battery compartment. The protective surface of the protective element points in the insertion direction. The pressure washer has at least one angular sector with respect to the circumferential direction around the insertion axis, in which the protective element overlaps the projection of the battery compartment with respect to the insertion direction in such a way that the projection lies in front of the protective surface with respect to the insertion direction. When inserting the battery pack into the battery compartment in the insertion direction, the battery pack first passes the projection of the battery compartment and only thereafter passes the protective surface of the protective element. This creates a kind of labyrinth seal. Liquid that has penetrated as far as the protective element, in particular as far as the protective surface of the protective element, must then still overcome the projection of the battery compartment in order to be able to penetrate through the insertion opening of the battery compartment into the battery compartment. The liquid must penetrate from the protective surface against the insertion direction towards the projection. The projection expediently protrudes transversely, in particular perpendicularly, to the insertion direction beyond the base body of the battery compartment and thus prevents the liquid from entering into the battery compartment.

The pressure washer can be placed on a stable surface provided for this purpose during operation. When the pressure washer is placed on a horizontal plane, the insertion direction runs substantially in the direction of gravity. In particular, the insertion direction has a vector component in the direction of gravity. Due to the arrangement of the projection in front of the protective surface with respect to the insertion direction, liquid must penetrate against the insertion direction on the way from the protective surface to the projection, and thus at least partially also against the direction of the weight force. This makes it easy to protect the battery pack and the battery compartment from liquid.

In particular, the insertion axis runs coaxially with a longitudinal center axis of the battery compartment. The insertion axis can also be referred to as the longitudinal center axis of the battery compartment.

The battery compartment has a longitudinal extension in the insertion direction. The projection is expediently arranged in a third of the battery compartment proximal to the longitudinal insertion end of the battery compartment. In particular, the projection is arranged in the quarter of the longitudinal extent which is proximal to the longitudinal insertion end. In particular, the projection is arranged at the outermost end of the battery compartment counter to the insertion direction. In particular, the projection is a collar of the battery compartment.

Advantageously, the at least one angular sector extends over an angular range of at least 45°, in particular of at least 90°, in particular of at least 120°.

In particular, the at least one angular sector extends over an angular range of at most 180°, in particular of at most 150°. However, it can also be provided that the at least one angular sector extends over exactly 360°.

Advantageously, the projection extends with respect to the circumferential direction over the entire at least one angular sector, in particular without gaps. As a result, the protective effect is provided by the projection in a large area. In particular, the protective surface extends with respect to the circumferential direction over the entire at least one angular sector, in particular without gaps. This also ensures that the protective surface provides protection over a large area.

In an advantageous configuration, there are several angular sectors with respect to the circumferential direction, in each of which the protective element overlaps the projection with respect to the insertion direction in such a way that the projection lies in front of the protective surface with respect to the insertion direction. Each of the plurality of angular sectors can also have the individual features described above and below with respect to the at least one angular sector.

Advantageously, the entire angular range of 360° around the insertion axis can be subdivided without gaps into angular sectors, in each of which the protective element, taken by itself, overlaps the projection with respect to the insertion direction in such a way that the projection lies in front of the protective surface with respect to the insertion direction. These individual angular sectors, which lie next to one another without gaps with respect to the circumferential direction, can also have the individual features described above and below with respect to the at least one angular sector. Because the entire angular range of 360° can be divided seamlessly into angular sectors in which the protective element overlaps the projection with respect to the insertion direction in such a way that the projection lies in front of the protective surface with respect to the insertion direction, the protective effect of both the projection and the protective element is ensured over the entire angular range of 360°. In particular, the protective element extends with respect to the circumferential direction in each of the angular sectors over the entire angular sector, in particular without gaps. In particular, the projection extends with respect to the circumferential direction in each of the angular sectors over the entire angular sector, in particular without gaps. In particular, in each angular sector, the projection lies in front of the protective surface with respect to the insertion direction. This relative relationship between projection and protective surface may not apply to the relationship between the projection from one angular sector and the protective surface from another angular sector.

Advantageously, a cavity is formed behind the projection with respect to the insertion direction. In particular, the cavity undercuts the projection with respect to the insertion direction. This causes the projection to protrude beyond the base body of the battery compartment. The cavity can effectively prevent liquid from penetrating the battery compartment and especially from reaching the battery pack.

Advantageously, the projection extends completely closed around the insertion axis. As a result, the projection protects the battery pack from liquid over the entire angular range of 360° around the insertion axis. A gap is expediently formed between the projection and the protective element, in particular in the radial direction. In particular, the projection is at a distance from the protective element in the radial direction. This allows the protective element to be easily movable relative to the projection.

In particular, the protective element is a wall. The wall expediently has an end face pointing in the insertion direction. In particular, the protective surface is formed by the end face of the wall. This allows the protective element and protective surface to be designed in a simple manner.

The battery compartment is expediently designed separately from the housing as an insert part. This makes it easy to manufacture the pressure washer. In particular, the projection of the battery compartment can be produced in a simple manner.

In an advantageous configuration the pressure washer has a liquid guide surface. The liquid guide surface runs around the insertion axis and/or around the battery compartment and/or around the base body of the battery compartment. In particular, the liquid guide surface runs in a closed manner around the insertion axis and/or the battery compartment and/or the base body of the battery compartment. Advantageously, the projection lies in front of the liquid guide surface with respect to the insertion direction in the at least one angular sector, in particular in all angular sectors, in particular in the angular sectors extending over the entire angular range of 360° without gaps. Advantageously, the liquid guide surface runs obliquely to the horizontal plane when the pressure washer is placed on the horizontal plane in the operating position provided for this purpose. Preferably, the protective surface lies in front of the liquid guide surface with respect to the insertion direction in the at least one angular sector, in particular in all angular sectors, in particular in the angular sectors extending over the entire angular range of 360° without gaps. Because the liquid guide surface is inclined, liquid can collect on the liquid guide surface and flow down to the lowest point of the liquid guide surface due to gravity. In particular, the pressure washer is configured to allow liquid to drain from the liquid guide surface to an outer side of the housing of the pressure washer due to gravity.

In particular, the liquid guide surface is formed by the battery compartment. In particular, the liquid guide surface protrudes radially beyond the base body of the battery compartment. Since the liquid guide surface is formed by the battery compartment, it can be manufactured in a simple manner. This makes it easy to seal a contact surface between the housing and the battery compartment.

The pressure washer advantageously comprises a cover for covering the battery compartment. In particular, the protective element is fixed to the cover. In particular, the protective element is a component of the cover. In particular, the cover has a main body. In particular, the protective element is fixed to the main body. In particular, the protective element protrudes beyond the main body in the insertion direction.

The cover is expediently arranged on the housing of the pressure washer so as to be pivotable about a pivot axis. This makes it easy to cover the battery compartment. The cover can be sealed in a simple and effective manner by the cooperation of the protective element fixed to the cover and the projection of the battery compartment. By fixing the protective element to the cover, the protective element can be easily positioned. This makes it easy to create a labyrinth seal. At the same time, the cover can be easily opened and the battery pack removed from the battery compartment.

Advantageously, the liquid guide surface has a highest point when the pressure washer is placed on the horizontal plane. In particular, the highest point with respect to the battery compartment is on the side of the pivot axis. This protects the pivot axis from excessive liquid loading. The liquid flows on the liquid guide surface in a direction away from the pivot axis. In particular, the cover can be pivotably mounted on the housing of the pressure washer by means of a joint. Due to the inclined arrangement of the liquid guide surface, this joint is protected from excessive stress caused by liquid.

The cover advantageously has an outer wall and an inner wall. In particular, the inner wall is the protective element. In particular, when the cover is closed, the inner wall is at a distance from the outer wall at the level of the projection in the radial direction with respect to the insertion direction. In particular, the outer wall bears tightly, in particular in a waterproof manner, against the housing of the pressure washer. In particular, the outer wall has an outer end face that bears tightly against the housing. As a result, a first barrier for liquid penetrating to the battery compartment is formed by the outer wall. The inner wall represents a second barrier. The projection on the battery compartment represents a third barrier.

When the cover is closed, the protective surface of the protective element expediently has a protective surface distance from the housing of the pressure washer, measured in the insertion direction. This makes it possible for the outer wall to fit tightly and without play against the housing. Due to the protective surface distance of the inner wall of the cover, the requirements for the manufacturing tolerances of the cover are low. In particular, the protective surface distance is less than 8 mm, in particular less than 5 mm. In particular, the protective surface distance is greater than 1 mm, in particular greater than 2 mm.

In particular, the cover has an outer wall. In particular, the housing has an outer side. In an advantageous development of the invention, it is provided that the outer wall is set back from the outer side of the housing. Because the outer wall of the cover is set back from the outer side of the housing, the outer wall of the cover does not offer any surface in the sense of a projection on which a force can act to open it, in particular to pivot the cover about the pivot axis. This prevents cleaning fluid from being sprayed against such a projection and causing the cover to be opened or pivoted unintentionally. Because the outer wall of the cover is set back from the outer side of the housing, the cover can rest on the housing without being secured. In particular, a return element can be provided which presses the cover against the housing in the direction of its closed position. A spring, in particular a torsion spring, can serve as a return element. A single spring can be sufficient to keep the cover reliably closed.

The outer wall of the cover, in particular of the main body of the cover, has an outer end face. When the cover is closed, the outer end face bears against a contact surface on the housing. The interaction between the housing and the outer wall of the cover creates a space that is sealed off from the outside.

Expediently, the outer wall of the cover in the region of the contact surface is arranged completely inside the outer side of the housing in the region of the contact surface with respect to the radial direction. As a result, the outer wall of the cover does not provide a surface for opening forces to attack, especially not for unintentional opening forces being applied to the cover. In particular, an outer side of the outer wall of the cover in the region of the contact surface, measured in the radial direction, has a smaller distance from the insertion axis of the battery compartment than the outer side of the housing.

The pressure washer may include a handle. The handle is arranged in particular on the outer wall of the cover. In particular, a penetration opening is formed through the handle in the direction tangential to the outer wall. If a force caused by the cleaning fluid acts on the handle, it is very small, since the cleaning fluid can pass through the penetration opening and no force can be transmitted to the handle and thus no force can be transmitted to the cover in the region of the penetration opening.

### BRIEF DESCRIPTION OF THE DRAWINGS

An embodiment of the invention is explained below with reference to the drawings.

FIG. 1 shows a perspective view of a pressure washer.

FIG. 2 shows a plan view from above of the pressure washer of FIG. 1.

FIG. 3 shows a perspective view of a part of the pressure washer of FIG. 1 with the cover open.

FIG. 4 is a perspective view of the section according to FIG. 3 with the cover removed.

FIG. 5 is a perspective view of a section along the section line V-V in FIG. 2.

FIG. 6 is a sectional view of a section along the section line VI-VI in FIG. 2.

FIG. 7 is a detail of a sectional view of a section along the section line V-V in FIG. 2.

FIG. 8 is a detail of a sectional view of a section along the section line VIII-VIII in FIG. 2, with a battery pack being inserted into the battery compartment.

FIG. 9 is a perspective sectional view of a section along the section line IX-IX in FIG. 2.

FIG. 10 is a detail (identified by X in FIG. 9) of a sectional view of a section along the sectional plane IX-IX in FIG. 2.

FIG. 11 shows a detailed view of a perspective view of the pressure washer from FIG. 1 with the cover removed and the latch lever that secures the battery pack in the battery compartment removed.

FIG. 12 shows a further perspective detail view of an area of the pressure washer from FIG. 11 marked XII in FIG. 11, and

FIG. 13 shows a detail of a view from above of the pressure washer from FIG. 1.

### DETAILED DESCRIPTION

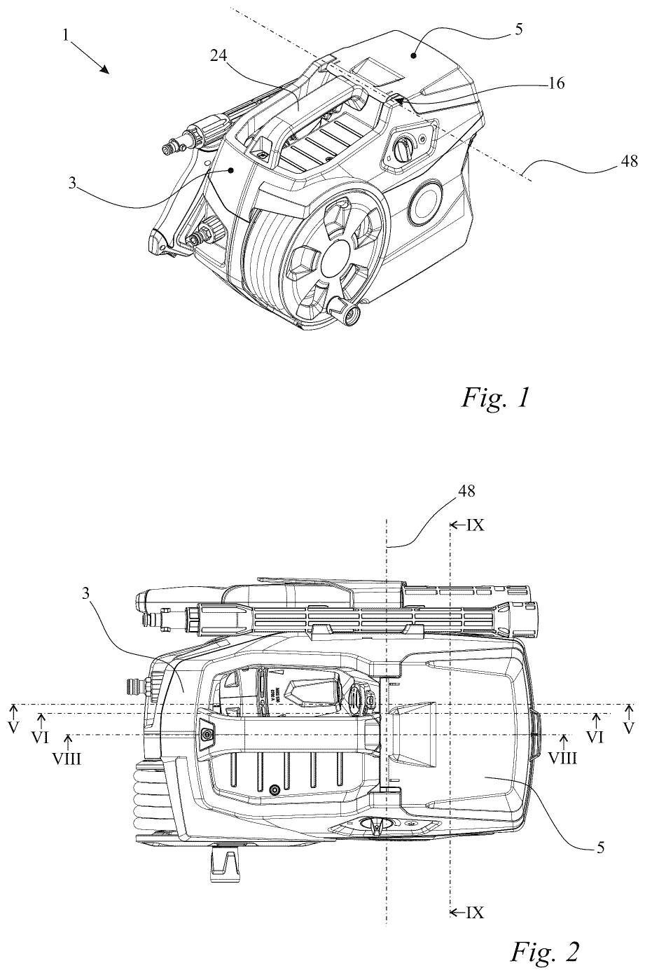

FIG. 1 shows a pressure washer 1, which may also be referred to as a high-pressure cleaning apparatus. The pressure washer 1 is designed for cleaning objects with pressurized cleaning fluid. In the exemplary embodiment, the pressure washer 1 is portable. The pressure washer 1 has a handle 24. The pressure washer 1 can be carried by the handle 24. During normal operation, the pressure washer 1 is set down on the ground. In the exemplary embodiment, the pressure washer 1 is a battery-powered cordless pressure washer.

The pressure washer 1 has a housing 3. The housing 3 at least partially delimits the pressure washer 1 toward the outside. The pressure washer 1 has a high-pressure pump (not shown). The high-pressure pump is arranged in the housing 3. Cleaning liquid in the pressure washer 1 can be pressurized by the high-pressure pump. By the high-pressure pump, the cleaning liquid can be placed under a pressure of at least 10 bar, in particular of at least 15 bar, in particular of at least 30 bar, in particular of at least 100 bar. In particular, the high-pressure pump can pressurize the cleaning fluid to a maximum of 600 bar, in particular a maximum of 500 bar. The pressure washer 1 comprises a motor (not shown). The motor is used to drive the high-pressure pump. The motor is located in the housing 3. In the exemplary embodiment, the motor is an electric motor, in particular a brushless DC motor.

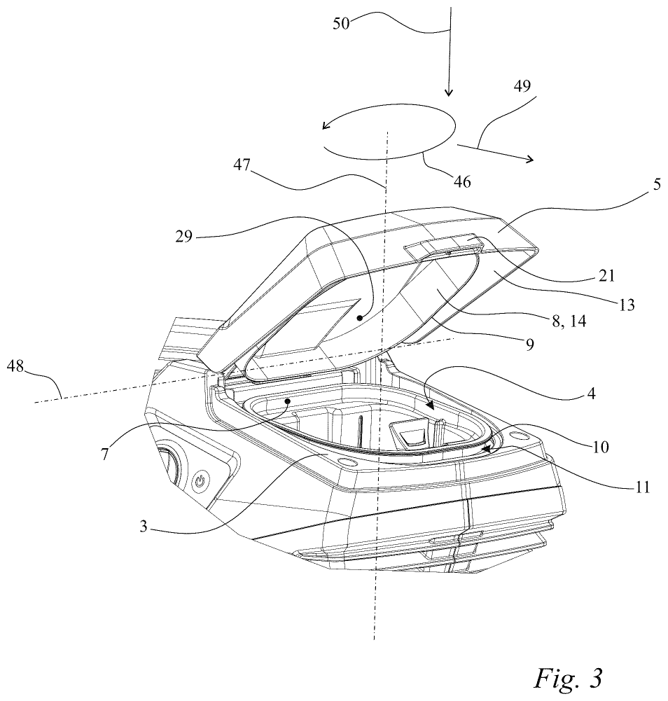

The pressure washer 1 comprises a battery compartment 4 shown, for example, in FIGS. 3 to 5. The battery compartment 4 is used to accommodate a battery pack 2. The battery pack 2 is shown in FIG. 8. In the exemplary embodiment, the battery compartment 4 is designed separately from the housing 3. The battery compartment 4 is designed as an insert part. The battery compartment 4 is attached to the housing 3. The battery compartment 4 protrudes into the housing 3. An opening is provided in the housing 3 for this purpose. The battery compartment 4 fills this opening.

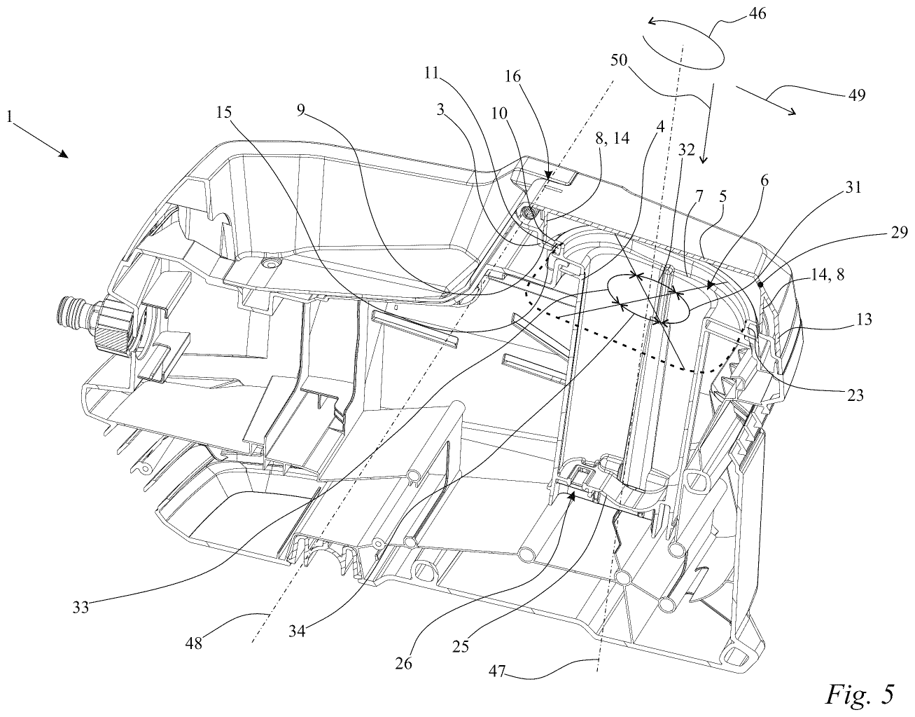

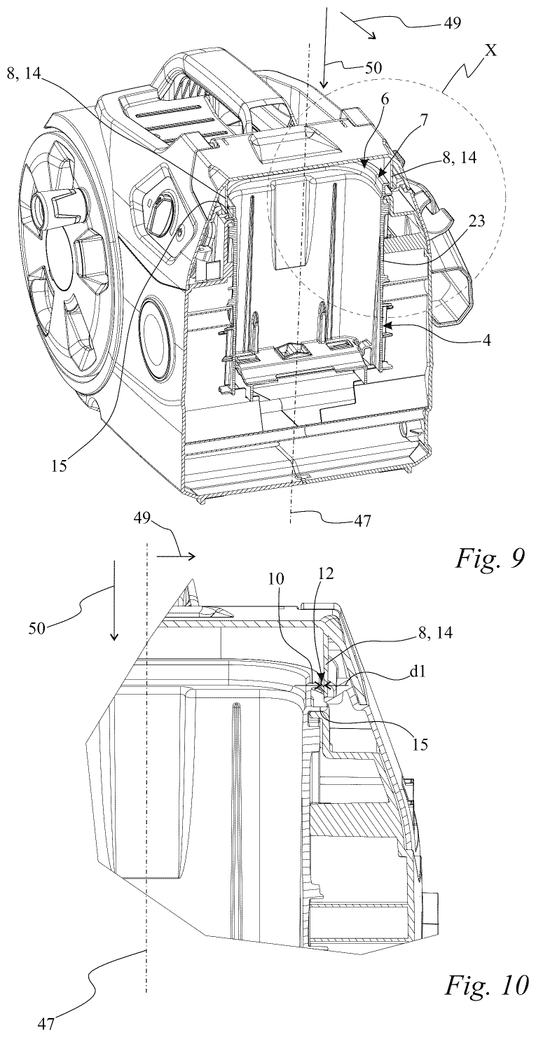

The battery pack 2 is used to supply the motor with energy. In particular, the battery pack 2 is the only energy source of the pressure washer 1. As can be seen in particular from FIGS. 5 and 9, the battery compartment 4 has a longitudinal insertion end 6. An insertion opening 7 is arranged at the longitudinal insertion end 6. The battery pack 2 can be inserted into the battery compartment 4 through the insertion opening 7. The battery pack 2 can be inserted into the battery compartment 4 in an insertion direction 50. The pressure washer 1 is designed in such a way that the battery pack 2 is guided by the battery compartment 4 in the insertion direction 50 when it is inserted into the battery compartment 4. During the insertion of the battery pack 2 into the battery compartment 4, the battery pack 2 rests against an inner wall of the battery compartment 4.

The battery pack 2 is moved along an insertion axis 47 in the insertion direction 50 when it is inserted into the battery compartment 4. The insertion axis 47 extends in the insertion direction 50. The battery compartment 4 has a longitudinal center axis. The longitudinal center axis runs coaxially with the insertion axis 47. The insertion axis 47 is also referred to as the longitudinal center axis of the battery compartment. The insertion axis 47 runs centrally with respect to the battery compartment 4. The inner wall of the battery compartment 4 delimits cross-sections of the battery compartment 4 that run perpendicular to the insertion axis 47. The insertion axis 47 runs through the geometric centroid of this cross section, at least with respect to one cross section.

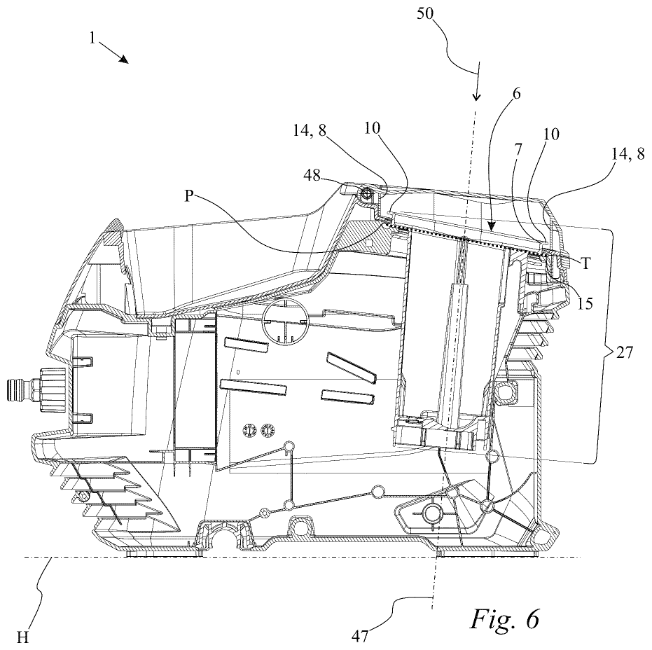

As shown in FIG. 6, the pressure washer 1 has an operating position for the intended operation. In this operating position, the pressure washer 1 can be placed on a horizontal plane H. In this position, the insertion direction 50 runs towards the horizontal plane H. In this position, the insertion direction 50 has a vectorial component in the direction of gravity. In the exemplary embodiment, the insertion direction 50 runs obliquely to the horizontal plane H. The insertion direction 50 encloses an angle of 45° to 90° with the horizontal plane H. The insertion axis 47 forms an angle of 45° to 90° with the horizontal plane H.

As shown, for example, in FIG. 3, the insertion opening 7 has an inner edge. The inner edge of the insertion opening 7 runs completely closed around the insertion axis 47. A circumferential direction 46 extends around the insertion axis 47. The circumferential direction 46 runs around the insertion axis 47 in an imaginary plane perpendicular to the insertion axis 47. The circumferential direction 46 extends along an imaginary circular line, in the center of which the insertion axis 47 lies.

As can be seen, for example, from FIG. 5, the battery compartment 4 has a bottom 25. The bottom 25 delimits the battery compartment 4 at its bottom longitudinal end 26. The bottom longitudinal end 26 of the battery compartment 4 lies opposite the longitudinal insertion end 6 of the battery compartment 4 with respect to the insertion direction 50. The bottom 25 is spaced apart from the insertion opening 7 with respect to the insertion direction 50. The battery pack 2 rests against the bottom 25 when it is inserted into the battery compartment 4.

As shown, for example, in FIG. 5, a radial direction 49 runs perpendicular to the insertion direction 50. The radial direction 49 runs perpendicular to the insertion axis 47. The radial direction 49 runs radially to the insertion axis 47. The radial direction 49 can point in any direction radial to the insertion axis 47. The radial direction 49 points away from the insertion axis 47. The inner wall of the battery compartment 4 delimits the battery compartment 4 in any radial direction 49. The inner wall of the battery compartment 4 runs closed around the insertion axis 47 in the circumferential direction 46.

As shown, for example, in FIG. 5, the pressure washer 1 has a protective element 8. The protective element 8 serves to protect the battery compartment 4 from liquid. The protective element 8 is also shown, for example, in FIG. 3, 6, 7, 8, 9 or 10.

The battery compartment 4 has a base body 23, as shown in FIG. 5. The base body 23 extends in the insertion direction 50 in the region of the longitudinal insertion end 6 of the battery compartment 4. The battery compartment 4 has a projection 10. The projection 10 is arranged in the region of the longitudinal insertion end 6 of the battery compartment 4. The projection 10 protrudes in the radial direction 49 beyond the base body 23 of the battery compartment 4.

The protective element 8 has a protective surface 9. The protective surface 9 is clearly visible in FIG. 3, for example. The protective surface 9 points in the insertion direction 50. In other words, the protective element 8 protrudes with its protective surface 9 in the insertion direction 50. The protective surface 9 is a free end of the protective element 8. The protective surface 9 delimits the protective element 8 in the insertion direction 50.

The protective surface 9 is arranged outside the base body 23 of the battery compartment 4 with respect to the radial direction 49. In particular, the protective surface 9 is arranged completely outside the base body 23 of the battery compartment 4 with respect to the radial direction 49. With respect to the radial direction 49, the protective surface 9 and the base body 23 of the battery compartment 4 do not overlap. The base body 23 of the battery compartment 4 is arranged completely within the protective surface 9 with respect to the radial direction 49. In the exemplary embodiment, the protective element 8 is arranged with respect to the radial direction 49 outside, in particular completely outside, the base body 23 of the battery compartment 4.

As shown in FIG. 5, the pressure washer 1 has at least one angular sector 31. The angular sector is a section of the angle in the circumferential direction around the insertion axis 47. The angular sector is part of the entire space. The angular sector is delimited at its angular tip by the insertion axis 47. Starting from the insertion axis 47, half-planes extend, which are each delimited by the insertion axis 47 and delimit the angular sector 31. In the radial direction 49 within the angular sector, the angular sector 31 is unlimited. In the insertion direction 50 and in the direction opposite to the insertion direction 50, the angular sector 31 is unlimited. The half-planes which delimit the at least one angular sector 31 are unlimited in the radial direction 49 and in the insertion direction 50 and in the direction opposite to the insertion direction. The half-planes are limited exclusively by the insertion axis 47. The insertion axis 47 is a straight line.

In the exemplary embodiment, the pressure washer 1 has at least one angular sector 31 in which the protective element 8 overlaps the projection 10 with respect to the insertion direction 50 such that the projection 10 lies in front of the protective surface 9 with respect to the insertion direction 50. In other words, in the at least one angular sector 31 the protective element 8 projects in the insertion direction beyond the projection 10 such that the protective surface is further away from the insertion opening 7 of the battery compartment 4 with respect to the insertion direction 50 than the projection 10 of the battery compartment 4. In the at least one angular sector 31, the projection 10 and the protective surface 9 do not overlap with respect to the insertion direction 50. With respect to the circumferential direction 46 over the entire at least one angular sector 31, the projection 10 lies in front of the protective surface 9 with respect to the insertion direction 50. For every point of the projection 10 within the at least one angular sector 31, it applies that it lies in front of any point of the protective surface 9 within the at least one angular sector 31 with respect to the insertion direction 50. As long as the part of the projection 10 from the at least one angular sector 31 is compared with the part of the protective surface 9 from the at least one angular sector 31, it applies that this part of the projection 10 lies in front of this part of the protective surface 9 with respect to the insertion direction 50.

In the exemplary embodiment, the at least one angular sector 31 extends over an angular range of at least 45°, in particular of at least 90°, in particular of at least 120°, in the circumferential direction 46 around the insertion axis 47.

In the exemplary embodiment, the at least one angular sector 31 extends over an angular range of at most 180°, in particular of at most 150°, in the circumferential direction 46 around the insertion axis 47. However, it can also be provided that the at least one angular sector 31 extends over an angular range of 360° in the circumferential direction 46 around the insertion axis 47. In this case, the protective element 8 overlaps the projection 10 with respect to the insertion direction 50 at any point such that the projection 10 lies in front of the protective surface 9 with respect to the insertion direction 50. In particular, the protective element 8 overlaps the projection 10 with respect to the insertion direction 50 such that any point of the projection 10 with respect to the insertion direction 50 lies in front of any point of the protective surface 9.

The projection 10 extends with respect to the circumferential direction 46 over the entire at least one angular sector 31, in particular without gaps. The protective surface 9 extends with respect to the circumferential direction 46 over the entire at least one angular sector 31, in particular without gaps.

As shown in FIG. 5, there are several angular sectors 31, 32, 33 and 34, in each of which the protective element 8 overlaps the projection 10 with respect to the insertion direction 50 in such a way that the projection lies in front of the protective surface 9 with respect to the insertion direction 50. The fact that the projection 10 lies in front of the protective surface 9 with respect to the insertion direction 50 applies in particular only to those parts of the projection 10 and those parts of the protective surface 9 that are to be assigned in pairs to the same angular sector 31, 32, 33 or 34.

In the exemplary embodiment, the entire angular range of 360° in the circumferential direction 46 around the insertion axis 47 can be subdivided without gaps into angular sectors 31, 32, 33, 34, in each of which the protective element 8 overlaps the projection 10 with respect to the insertion direction 50 in such a way that the projection 10 lies in front of the protective surface 9 with respect to the insertion direction 50. In the exemplary embodiment, there are four angular sectors 31, 32, 33, 34, in each of which the condition is met that the protective element 8 overlaps the projection 10 with respect to the insertion direction 50 such that the projection 10 lies in front of the protective surface 9 with respect to the insertion direction 50. In the individual angular sectors 31, 32, 33, 34, the protective element 8 overlaps the projection 10 with respect to the insertion direction 50 such that the entire projection 10 lies in the respective angular sector 31, 32, 33 or 34 with respect to the insertion direction 50 completely in front of the part of the protective surface 9 from the same angular sector 31, 32, 33, 34.

In the exemplary embodiment, the four angular sectors 31, 32, 33 and 34 are of the same size. In the exemplary embodiment, the four angular sectors 31, 32, 33, 34 each extend in the circumferential direction 46 around the insertion axis 47 over an angle of exactly 90°. This is shown only schematically in FIG. 5. The course of the projection 10 in the area not shown due to the section is shown schematically in FIG. 5 with a thick dashed line. The above-described half planes, which delimit the individual angular sectors 31, 32, 33, 34, are not shown for the sake of clarity. The half-planes contain the boundary lines of the individual angular sectors 31, 32, 33, 34 drawn in FIG. 5 and are each limited by the insertion axis 47. Each angular sector 31, 32, 33, 34 is delimited by two half-planes and the insertion axis 47.

As shown in FIG. 6, the battery compartment 4 has a longitudinal extension 27 with respect to the insertion direction 50. The longitudinal extension 27 has a front third with respect to the insertion direction 50. The longitudinal extension 27 has a front quarter with respect to the insertion direction 50. The front third of the longitudinal extension 27 is proximal to the insertion opening 7. The front quarter of the longitudinal extension 27 is proximal to the insertion opening 7. The front third of the longitudinal extension 27 is proximal to the longitudinal insertion end 6. The front quarter of the longitudinal extension 27 is assigned to the longitudinal insertion end 6. The front third of the longitudinal extension 27 lies at the edge of the longitudinal extension 27. The front quarter of the longitudinal extension 27 lies at the edge of the longitudinal extension 27. The projection 10 of the battery compartment 4 is arranged in the front third of the longitudinal extension 27. In the exemplary embodiment, the projection 10 of the battery compartment 4 is arranged in the front quarter of the longitudinal extension 27.

In the exemplary embodiment, the projection 10 forms a collar of the battery compartment 4. In the exemplary embodiment, the projection 10 is arranged at the outermost end of the battery compartment 4 with respect to the direction counter to the insertion direction 50. The projection 10 forms an edge of the battery compartment 4. The projection 10 delimits the battery compartment 4 in the direction opposite to the insertion direction 50.

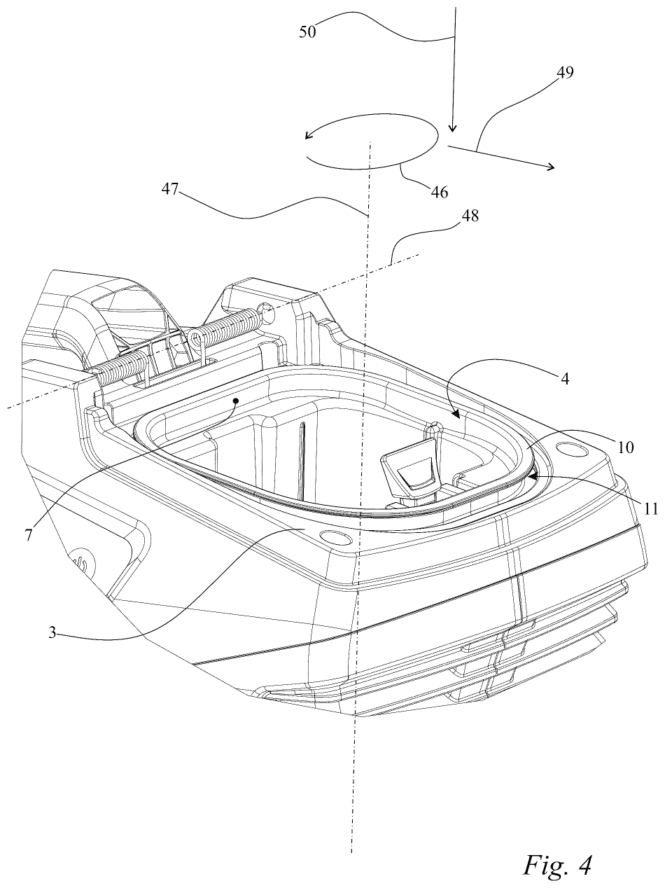

As can be seen in particular in FIGS. 4 and 5, a cavity 11 is formed behind the projection 10 with respect to the insertion direction 50. The cavity 11 undercuts the projection 10 with respect to the insertion direction 50. With respect to the insertion direction 50, the cavity 11 lies on the side of the projection 10 that faces away from the insertion opening 7 of the battery compartment 4.

As shown in FIGS. 3 and 4, the projection 10 runs completely closed around the insertion axis 47. The projection 10 extends uninterruptedly around the insertion axis 47 with respect to the circumferential direction 46.

As can be seen in FIG. 3 in conjunction with FIGS. 5 and 9, for example, the protective surface 9 of the protective element 8 runs completely closed around the insertion axis 47. In the exemplary embodiment, this applies at least to the operating state of the pressure washer 1. The protective surface 9 extends in the circumferential direction 46 without interruption around the insertion axis 47.

As shown in FIG. 10, a gap 12 is formed between the projection 10 and the protective element 8, in particular in the radial direction 49. The projection 10 is at a distance d1 from the protective element 8 in the radial direction 49.

As shown in FIG. 3, the protective element 8 is a wall. The wall has an end face. The end face of the wall is the protective surface 9 of the protective element 8 designed as a wall. As shown in FIG. 5, the end face points in the insertion direction 50 in the operating state of the pressure washer 1. In the operating state of the pressure washer 1, the end face of the wall faces away from the insertion opening 7. As can be seen from the combination of FIGS. 3, 5 and 9, the wall runs closed around the insertion axis 47.

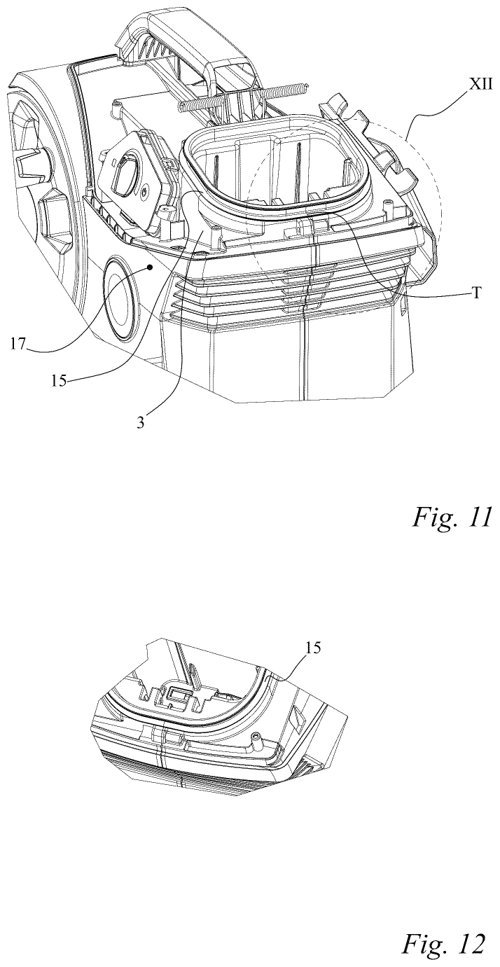

As shown in FIGS. 5 and 9 to 12, the pressure washer 1 has a liquid guide surface 15. The liquid guide surface 15 extends around the insertion axis 47. In particular, the liquid guide surface 15 extends closed around the insertion axis 47. In particular, the liquid guide surface 15 extends without interruption around the insertion axis 47 with respect to the circumferential direction 46. The liquid guide surface 15 extends around the battery compartment 4, in particular around the base body 23 of the battery compartment 4. The liquid guide surface 15 extends in a closed manner around the battery compartment 4, in particular around the base body 23 of the battery compartment 4. The liquid guide surface 15 extends without interruption in the circumferential direction 46 around the battery compartment 4, in particular around the base body 23 of the battery compartment 4.

As shown in FIG. 5, the projection 10 lies in the at least one angular sector 31, 32, 33, 34, in particular in all angular sectors 31, 32, 33 and 34, in particular in the angular sectors 31, 32, 33, 34 extending over the entire angular range of 360° without gaps with respect to the insertion direction 50 in front of the liquid guide surface 15. This applies to each of the angular sectors 31, 32, 33, 34 individually. However, it can also be provided that this applies to an angular sector extending over 360°. In FIG. 6, the position of the liquid guide surface 15 is shown schematically with a thick dashed line. When the pressure washer 1 is placed on the horizontal plane H in the operating position provided for this purpose, the liquid guide surface 15 runs obliquely to the horizontal plane H. In particular, the liquid guide surface 15 is inclined at an angle of at least 5° to the horizontal plane H. In particular, the liquid guide plane 15 is inclined at an angle of at most 30° to the horizontal plane H. In particular, the liquid guide surface 15 is inclined at an angle of 60° to 85° against the insertion direction 50. This is the case regardless of the operating position.

In particular, the liquid guide surface 15 extends in a plane.

As can best be seen in FIG. 3, the pressure washer 1 comprises a cover 5. The cover 5 serves to cover the battery compartment 4. In the exemplary embodiment, the cover 5 is designed to completely cover the battery compartment 4 in the closed state. As can be seen in FIG. 3, the protective element 8 is fixed to the cover 5. The cover 5 has a main body 29. The protective element 8 is part of the cover 5. The protective element 8 is fixed to the main body 29. In the closed state of the cover 5 shown in FIG. 5, the protective element 8 projects from the main body 29 in the insertion direction 50 onto the housing 3 of the pressure washer 1.

The cover 5 is arranged on the housing 3 of the pressure washer 1 so as to be pivotable about a pivot axis 48, as shown in FIG. 3. As can be seen in FIG. 6, the pressure washer 1 is designed in such a way that the liquid guide surface 15 guides liquid away from the pivot axis 48. When the pressure washer 1 is placed on the horizontal plane H, the liquid guide surface 15 has a highest point P. The highest point P of the liquid guide surface 15 is on the side of the pivot axis 48 with respect to the battery compartment 4. Starting from the highest point P, liquid will flow on the liquid guide surface 15 away from the pivot axis 48 due to the action of gravity.

The cover 5 is mounted on the housing 3 so as to be pivotable about the pivot axis 48 by means of a joint 16 (FIG. 8). Since the liquid guide surface 15 guides liquid away from the pivot axis 48, the joint 16 is subjected to less stress from liquid. As can be seen in particular from FIGS. 9 and 11, the liquid guide surface 15 is formed by the battery compartment 4. The liquid guide surface 15 protrudes in the radial direction 49 beyond the base body 23 of the battery compartment 4.

As shown in FIG. 11, liquid can flow from the liquid guide surface 15 onto the housing 3, in particular onto the outer side 17 of the housing 3. When the pressure washer 1 is placed on the horizontal plane H, the liquid guide surface 15 has a lowest point T. This is also shown in FIG. 6. The lowest point T of the liquid guide surface 15 is on the side facing away from the pivot axis 48 with respect to the battery compartment 4. Due to the action of gravity, liquid will flow on the liquid guide surface 15 to the lowest point T. The lowest point T is a collection point for liquid. The pressure washer 1 is designed in such a way that the liquid flows from the lowest point T onto the housing 3, in particular onto the outer side 17 of the housing 3. The housing 3 is arranged in a dome-like manner around the liquid guide surface 15.

During normal operation of the pressure washer 1, the cover 5 is closed. In the operating state of the pressure washer 1, the cover 5 of the pressure washer 1 is closed. As shown in FIG. 8, the pressure washer 1 comprises a return element 28. The return element 28 biases the cover 5 in its closed state. The return element 28 biases the cover 5 towards the housing 3. In the exemplary embodiment, the return element 28 is a torsion spring. The return element 28 causes a force in the direction around the pivot axis 48. The return element 28 presses the cover 5 towards the housing 3. The cover 5 is biased towards the housing 3.

The first angular sector 31 shown in FIG. 4 opens in a direction away from the pivot axis 48. The second angular sector 32 opens in one direction of the pivot axis 48. The third angular sector 33 opens towards the pivot axis 48. The fourth angular sector opens in another direction of the pivot axis 48. The first angular sector 31 opens towards the lowest point T of the liquid guide surface 15. The third angular sector 33 opens towards the highest point P of the liquid guide surface 15. The first angular sector 31 contains the lowest point T of the liquid guide surface 15. The third angular sector 33 contains the highest point P of the liquid guide surface 15.

As can be seen in particular in FIG. 3, the cover 5 has an outer wall 13 and an inner wall 14. The inner wall 14 is the protective element 8. The protective element 8 is formed by the inner wall 14. With the cover 5 closed, the inner wall 14 lies further inward with respect to the radial direction 49 than the outer wall 13.

It can be provided that the outer wall 13 completely encloses the inner wall 14 in the circumferential direction 46 when the cover 5 is closed. When the cover 5 is closed, the outer wall 13 then runs closed around the insertion axis 47 in the circumferential direction 46.

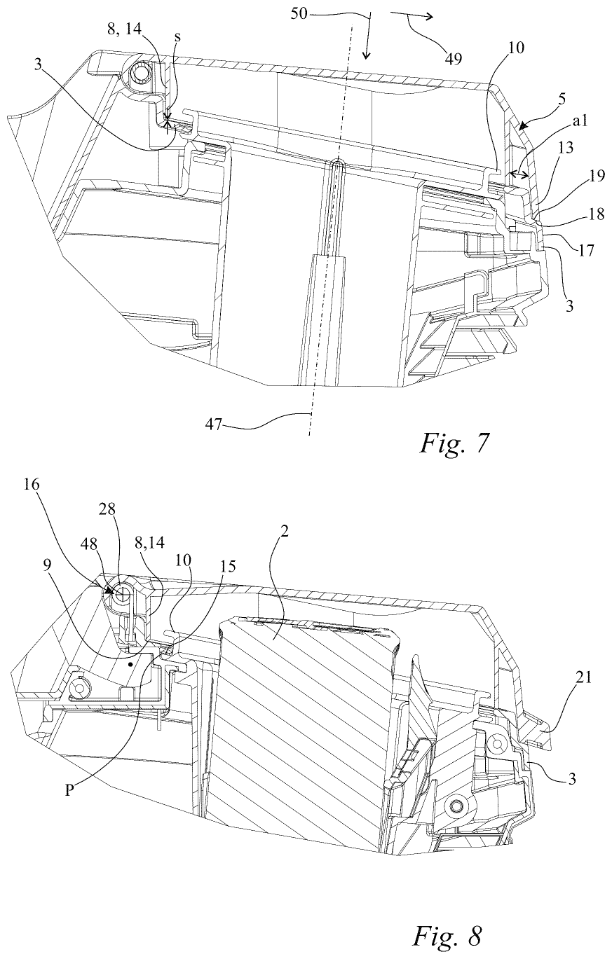

In the exemplary embodiment, the inner wall 14 runs closed around the insertion axis 47 in the circumferential direction 46 when the cover 5 is closed. With the cover 5 closed, the inner wall 14 is at a distance al from the outer wall 13 at the level of the projection 10 in the radial direction 49 with respect to the insertion direction 50. This is shown in FIG. 7. The distance al is the smallest distance between the inner wall 14 and the outer wall 13 with respect to all conceivable radial directions 49.

The outer wall 13 of the cover 5 forms a first barrier against the penetration of liquid into the battery compartment 4. The inner wall 14 of the cover 5 forms a second barrier against the penetration of liquid into the battery compartment 4.

As shown in FIG. 7, the protective surface 9 of the protective element 8 has a protective surface distance s from the housing 3 of the pressure washer 1, measured in the insertion direction 50, when the cover 5 is closed. In the exemplary embodiment, the protective surface distance s is at most 8 mm, in particular at most 5 mm. In the exemplary embodiment, the protective surface distance s is at least 1 mm, in particular at least 2 mm.

As shown in FIG. 7, the outer wall 13 has an outer end face 18. The housing 3 has a contact surface 19. The contact surface 19 serves to contact the outer end face 18 on the housing 3.

It can be provided that the cover 5, in the closed state of the cover 5, rests with the outer end face 18 of the outer wall 13 on the contact surface 19 of the housing 3 at least indirectly via a sealing element. In the exemplary embodiment, the outer end face 18 of the outer wall 13 rests directly on the contact surface 19 of the housing 3 in the closed state of the cover 5.

As shown in FIG. 7, the housing 3 has an outer side 17. The outer wall 13 of the cover 5 is set back from the outer side 17 of the housing 3 in the closed state of the cover 5. The outer wall 13 of the cover 5 is arranged in the region of the contact surface 19 of the housing 3 completely within the outer side 17 of the housing 3 in the region of the contact surface 19 with respect to the radial direction 49. In the region of the contact surface 19 of the housing 3, the outer side 20 of the outer wall 13 of the cover 5, measured in the radial direction 49, has a smaller distance from the insertion axis 47 of the battery compartment 4 than the outer side 17 of the housing 3. The two distances compared with one another are measured in identical radial directions 49. In other words, the two distances with respect to the circumferential direction 46 are measured at the same point. The outer wall 13 is arranged in the region of the contact surface 19 with respect to the radial direction 49 over the entire angular range of 360° in the circumferential direction 46 around the insertion axis 47 completely within the outer side 17 of the housing 3 in the region of the contact surface 19. With respect to the insertion direction 50 in the region of the contact surface 19, the outer wall 13 of the cover 5 does not protrude at any point in the radial direction 49 beyond the outer side 17 of the housing 3 with respect to the insertion direction 50 in the region of the contact surface 19.

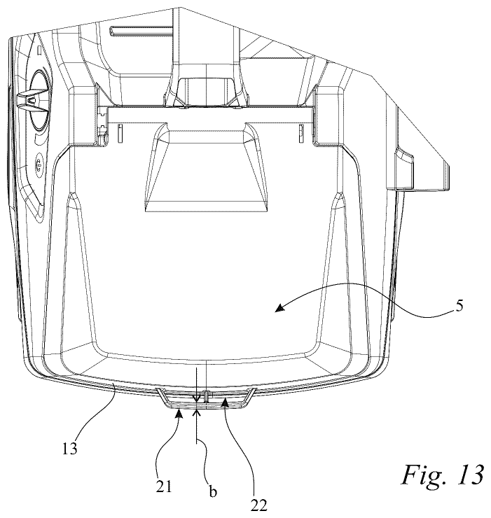

As shown in FIG. 13, the pressure washer 1 has a handle 21. The handle 21 is arranged on the outer wall 13 of the cover 5. A penetration opening 22 is formed by the handle 21 in the direction tangential to the outer wall 13. The handle 21 encloses the penetration opening 22 together with the cover 5. The handle 21 delimits the penetration opening 22 with a handle wall. The handle wall has a wall thickness. In the exemplary embodiment, the wall thickness of the handle wall is less than 8 mm, in particular less than 6 mm. The handle 21, in particular the handle wall, has a maximum limiting width b as seen in the direction tangential to the outer wall 13 of the cover 5. In the exemplary embodiment, the maximum limiting width b of the handle 21, in particular the handle wall, is less than 8 mm, in particular less than 6 mm. The handle wall of the handle 21 runs partially parallel to the outer wall 13 of the cover 5.

What is claimed is:

1. A pressure washer, comprising:
a motor for a high-pressure pump;
a battery pack (2) to supply the motor with energy;
a battery compartment (4) for the battery pack (2); and
a housing (3),
wherein the battery compartment (4) has a longitudinal insertion end (6) at which an insertion opening (7) is arranged,
wherein the battery compartment (4) has a base body (23),
wherein the battery pack (2) can be inserted into the battery compartment (4) in an insertion direction (50) along an insertion axis (47) through the insertion opening (7),
wherein a circumferential direction (46) runs around the insertion axis (47),
wherein the pressure washer (1) has a protective element (8) for protecting the battery compartment (4) from liquid,
wherein a radial direction (49) runs radially to the insertion axis (47),
wherein the protective element (8) has a protective surface (9),
wherein the protective surface (9) is arranged outside the base body (23) of the battery compartment (4) with respect to the radial direction (49),
wherein the battery compartment (4) has a projection (10) in a region of the longitudinal insertion end (6),
wherein the projection (10) projects in the radial direction (49) beyond the base body (23) of the battery compartment (4),
wherein the protective surface (9) points in the insertion direction (50), and
wherein the pressure washer (1) has at least one angular sector (31, 32, 33, 34) with respect to the circumferential direction (46) around the insertion axis (47), in which angular sector the protective element (8) overlaps the projection (10) with respect to the insertion direction (50) in such a way that the projection (10) lies in front of the protective surface (9) with respect to the insertion direction (50).

2. The pressure washer according to claim 1,
wherein the at least one angular sector (31, 32, 33, 34) extends over an angular range of at least 45°.

3. The pressure washer according to claim 1,
wherein the at least one angular sector (31, 32, 33, 34) extends over an angular range of at most 180°.

4. The pressure washer according to claim 1,
wherein the projection (8) and/or the protective surface (9) extends with respect to the circumferential direction (46) entirely over the at least one angular sector (31, 32, 33).

5. The pressure washer according to claim 1,
wherein there are several angular sectors (31, 32, 33, 34) around the insertion axis (47) with respect to the circumferential direction (46), in each of which the protective element (8) overlaps the projection (10) with respect to the insertion direction (50) in such a way that the projection (10) lies in front of the protective surface (9) with respect to the insertion direction (50).

6. The pressure washer according to claim 1,
wherein an entire angular range of 360° in the circumferential direction (46) around the insertion axis (47) can be subdivided without gaps into angular sectors (31, 32, 33), in each of which the protective element (8) overlaps the projection (10) with respect to the insertion direction (50) entirely in the respective angular sector (31, 32, 33) in such a way that the projection (10) lies in front of the protective surface (9) with respect to the insertion direction (50).

7. The pressure washer according to claim 1,
wherein a cavity (11) is formed behind the projection (10) with respect to the insertion direction (50), said cavity undercutting the projection (10) with respect to the insertion direction (50).

8. The pressure washer according to claim 1,
wherein the projection (10) runs completely closed around the insertion axis (47).

9. The pressure washer according to claim 1,
wherein a gap (12) is formed between the projection (10) and the protective element (8).

10. The pressure washer according to claim 1,
wherein the protective element (8) is a wall,
wherein the wall has an end face pointing in the insertion direction (50), and
wherein the protective surface (8) is formed by the end face of the wall.

11. The pressure washer according to claim 1,
wherein the battery compartment (4) is formed separately from the housing (3) as an insert part.

12. The pressure washer according to claim 1,
wherein the pressure washer (1) has a liquid guide surface (15),
wherein the liquid guide surface (15) extends around the insertion axis (47) and/or around the base body (23) of the battery compartment (4),
wherein the projection (10) lies in the at least one angular sector (31, 32, 33, 34) in front of the liquid guide surface (15) with respect to the insertion direction (50), and
wherein the liquid guide surface (15) runs obliquely with respect to a horizontal plane (H) when the pressure washer (1) is placed on the horizontal plane (H) in an operating position provided for this purpose.

13. The pressure washer according to claim 1,
wherein the pressure washer (1) comprises a cover (5) for covering the battery compartment (4), and
wherein the protective element (8) is fixed to the cover (5).

14. The pressure washer according to claim 12,
wherein the liquid guide surface (15) has a highest point (P) when the pressure washer (1) is placed on the horizontal plane (H), and
wherein the highest point (P) is on a side of a pivot axis (48) with respect to the battery compartment (4).

15. The pressure washer according to claim 12,
wherein the liquid guide surface (15) is formed by the battery compartment (4).

16. The pressure washer according to claim 13,
wherein the cover (5) has an outer wall (13) and an inner wall (14), and
wherein the inner wall (14) is the protective element (8).

17. The pressure washer according to claim 13,
wherein the protective surface (9) of the protective element (8) has a protective surface distance(s) from the housing (3) of the pressure washer (1) measured in the insertion direction (50) when the cover (5) is closed.

18. The pressure washer according to claim 16,
wherein the outer wall (13) has an outer end face (18), and
wherein the outer end face (18) bears against a contact surface (19) on the housing (3).

19. The pressure washer according to claim 18,
wherein the cover (5) has an outer wall (13),
wherein the housing (3) has an outer side (17), and
wherein the outer wall (13) is set back with respect to the outer side (17) of the housing (3).

20. The pressure washer according to claim 19,
wherein the outer wall (13) in a region of the contact surface (19) is arranged completely within the outer side (17) of the housing (3) in the region of the contact surface (19) with respect to the radial direction (49).

21. The pressure washer according to claim 16,
wherein the pressure washer (1) has a handle (21) which is arranged on the outer wall (13).
